(19) United States
(12) Patent Application Publication
(10) Pub. No.: US 2025/0379235 A1
(43) Pub. Date: Dec. 11, 2025

(54) FLUORIDE ION CONDUCTOR, NEGATIVE ELECTRODE MIXTURE AND FLUORIDE ION BATTERY

(71) Applicants: TOYOTA JIDOSHA KABUSHIKI KAISHA, Toyota-shi (JP); INSTITUTE OF SCIENCE TOKYO, Tokyo (JP)

(72) Inventors: Takeshi TOJIGAMORI, Sunto-gun (JP); Naoki Matsui, Tokyo-to (JP); Ryoji Kanno, Tokyo-to (JP)

(73) Assignees: TOYOTA JIDOSHA KABUSHIKI KAISHA, Toyata-shi (JP); INSTITUTE OF SCIENCE TOKYO, Tokyo (JP)

(21) Appl. No.: 19/171,687

(22) Filed: Apr. 7, 2025

(30) Foreign Application Priority Data
Jun. 5, 2024 (JP) 2024-091639

(51) Int. Cl. H01M 4/62; C01F 11/00; H01M 10/05

(52) U.S. Cl. CPC H01M 4/624; C01F 11/00; H01M 10/05; C01P 2002/34; C01P 2002/72; C01P 2002/88; C01P 2006/40

(57) ABSTRACT

The present disclosure provides a fluoride ion conductor having a perovskite structure with high ionic conductivity, a negative electrode mixture comprising the fluoride ion conductor, and a fluoride ion battery comprising the negative electrode mixture. The fluoride ion conductor of the disclosure has a perovskite structure, and is represented by the following formula (1): Ba_{1-x-y}SrₓA_{y}LiF_{3-y}: (1) wherein; A is an alkali metal element selected from among Na, K, Rb and Cs, 0.3<3 1−x−y<1.0, 0≤x<0.4, and 0<y<0.6. The negative electrode mixture of the disclosure comprises a fluoride ion conductor of the disclosure. The fluoride ion battery 1 of the disclosure has a negative electrode active material layer 20, the negative electrode active material layer comprising a negative electrode mixture of the disclosure.

### FIELD

The present disclosure relates to a fluoride ion conductor, to a negative electrode mixture and to a fluoride ion battery.

### BACKGROUND

Fluoride ion conductors are known which have a perovskite structure, as disclosed in NPL 1 and PTLs 1 to 4.

### CITATION LIST

### Non Patent Literature

[NPL 1] A. Duvel et al., “Access to metastable complex ion conductors via mechanosynthesis: preparation, microstructure and conductivity of (Ba, Sr) LiF₃ with inverse perovskite structure.” Journal of Materials Chemistry, 2011, vol. 21, p. 6238-6250

### PATENT LITERATURE

[PTL 1] Japanese Unexamined Patent Publication No. 2020-092037
[PTL 2] International Patent Publication No. WO2019/187942
[PTL 3] Japanese Unexamined Patent Publication No. 2018-041672
[PTL 4] Japanese Unexamined Patent Publication No. 2018-041673

### SUMMARY

### Technical Problem

For fluoride ion conductors having a perovskite structure, there is room for improvement in terms of ionic conductivity.

It is an object of the present disclosure to provide a fluoride ion conductor having a perovskite structure with high ionic conductivity, a negative electrode mixture comprising the fluoride ion conductor, and a fluoride ion battery comprising the negative electrode mixture.

### Solution to Problem

The present inventors have found that the aforementioned object can be achieved by the following means.

### <Aspect 1>

A fluoride ion conductor having a perovskite structure, and represented by the following formula (1):

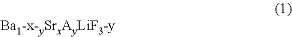

wherein;
A is an alkali metal element selected from among Na, K, Rb and Cs,

$$0.3 < 1 - x - y < 1. , 0 \leq x < 0.4 , and \\ 0 < y < 0.6 .$$

### <Aspect 2>

The fluoride ion conductor according to aspect 1, wherein

(i) in formula (1):

$$x = 0 , and \\ 0 < y \leq 0.3 ,$$

or
(ii) in formula (1):

$$0.4 < 1 - x - y < 1. , 0 < x < 0.4 , 0 < y < 0.4 , and \\ 2 y - x \leq 0.4 .$$

### <Aspect 3>

The fluoride ion conductor according to aspect 1 or 2, wherein in formula (1), A is K.

### <Aspect 4>

A negative electrode mixture comprising a fluoride ion conductor according to any one of aspects 1 to 3.

### <Aspect 5>

A fluoride ion battery,
having a negative electrode active material layer,
wherein the negative electrode active material layer comprises a negative electrode mixture according to aspect 4.

### Advantageous Effects of Invention

According to the present disclosure, it is possible to provide a fluoride ion conductor having a perovskite structure with high ionic conductivity, a negative electrode mixture comprising the fluoride ion conductor, and a fluoride ion battery comprising the negative electrode mixture.

### BRIEF DESCRIPTION OF DRAWINGS

FIG. 1 is a simplified cross-sectional view showing an example of a fluoride ion battery of the disclosure.

FIG. 2 shows XRD patterns for the fluoride ion conductors of Examples 1 to 17, Comparative Examples 1 to 6 and a Reference Example.

FIG. 3 is a graph showing the relationship between temperature and ion conductivity for the fluoride ion conductors of Examples 4 and 15.

FIG. 4 shows charging curves for batteries comprising the fluoride ion conductors of Examples 4, 7 and 15, in an electrode mixture.

FIG. 5 shows a charge-discharge curve for a fluoride ion battery comprising LaF₃ as the negative electrode active material, and the fluoride ion conductor of Example 15, in a negative electrode mixture.

FIG. 6 shows a charge-discharge curve for a fluoride ion battery comprising CeF₃ as the negative electrode active material, and the fluoride ion conductor of Example 15, in a negative electrode mixture.

FIG. 7 shows XRD patterns for the fluoride ion conductors of Examples 18 to 28 and Comparative Example 7.

### DESCRIPTION OF EMBODIMENTS

An embodiment of the disclosure will now be described in detail. The disclosure is not limited to the embodiment described below, however, and various modifications may be implemented which do not depart from the gist thereof.

### <<Fluoride Ion Conductor>>

The fluoride ion conductor of the disclosure has a perovskite structure, and is represented by the following formula (1):

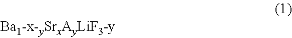

wherein;
A is an alkali metal element selected from among Na, K, Rb and Cs,

$$0.3 < 1 - x - y < 1. , 0 \leq x < 0.4 , and \\ 0 < y < 0.6 .$$

The present inventors have found, unexpectedly, that if part of the divalent alkaline earth metal element in Ba₁₋ₓSrₓLiF₃ as the fluoride ion conductor having a perovskite structure, as disclosed in NPL 1, is replaced with a monovalent alkali metal element, it is possible to improve the ionic conductivity of the fluoride ion conductor.

Without being restricted to any particular theory, the reason for this is conjectured to be as follows.

Specifically, replacing part of Ba₁₋ₓSrₓ in Ba₁₋ₓSrₓLiF₃ with a monovalent alkali metal element of lower valency allows formation of Ba_{1-x-y}SrₓA_{y}LiF_{3-y}, wherein A is the alkali metal element) In Ba_{1-x-y}SrₓA_{y}LiF_{3-y}, it is thought that holes are formed to maintain electrical neutrality. Fluoride ion tends to diffuse through the holes, possibly for this reason resulting in improved ionic conductivity of the fluoride ion conductor.

It is thought that an optimal range exists for the proportion of replacement with A. More specifically, a higher proportion of replacement with A increases the proportion of holes in the fluoride ion conductor, resulting in higher ionic conductivity. An excessively high proportion of replacement with A, however, tends to form impurities that do not contribute to ion conduction, resulting in lower ionic conductivity.

Regarding the ratio of Ba and Sr as well, a high proportion of Sr tends to form impurities that do not contribute to ion conduction, resulting in lower ionic conductivity.

The elements of the fluoride ion conductor of the disclosure will now be described.

In formula (1) representing the fluoride ion conductor of the disclosure, A is an alkali metal element selected from among Na, K, Rb and Cs. As mentioned above, it is possible that replacement of some of the Ba₁₋ₓSrₓ in Ba₁₋ₓSrₓLiF₃ with monovalent alkali metal elements of lower valency helps to facilitate diffusion of fluoride ions through the holes formed in the fluoride ion conductor, thus improving the ionic conductivity of the fluoride ion conductor.

In formula (1), 1-x-y, x and y represent the respective compositional ratios of Ba, Sr and A, with ranges of 0.3<1-x-y<1.0, 0≤x<0.4 and 0<y<0.6. If 1-x-y, x and y are within these ranges it will be possible to form a suitable proportion of holes in the fluoride ion conductor, thus helping to inhibit formation of impurities that do not contribute to ion conduction. This can presumably increase the ionic conductivity of the fluoride ion conductor to a suitable degree.

For the fluoride ion conductor of the disclosure, the following condition is satisfied: (i) in formula (1),

$$x = 0 , and \\ 0 < y \leq 0.3 .$$

In addition, for the fluoride ion conductor of the disclosure, the following condition is satisfied:

(ii) in formula (1),

$$0.4 < 1 - x - y < 1. , 0 < x < 0.4 , 0 < y < 0.4 , and \\ 2 y - x \leq 0.4 .$$

As explained below, the fluoride ion conductor of the disclosure may be included as part of the negative electrode mixture of a fluoride ion battery, or in other words, it may be used as an ionic conductor (electrolyte) for a negative electrode. In this case the fluoride ion conductor preferably does not undergo reductive decomposition. In this regard, if the parameters representing the compositional ratios in formula (1) satisfy the aforementioned values and ranges, then the reduction resistance can be improved when the fluoride ion conductor of the disclosure is used as an ionic conductor for a negative electrode comprising a negative electrode active material with low potential. Without being restricted to any particular theory, the reason for this is conjectured to be as follows. Specifically, it is possible that the reduction resistance is improved because the fluoride ion conductor of the disclosure has an alkaline earth metal element and alkali metal element with low oxidation-reduction potential, with the parameters for the compositional ratios in formula (1) limited to suitable ranges.

For the fluoride ion conductor of the disclosure, A is K in formula (1) may be satisfied. With this structure it is possible to reduce material costs while achieving high ionic conductivity.

The method of producing the fluoride ion conductor of the disclosure is not particularly restricted, and for example, it may be a method of applying mechanical impact to the starting compounds. The method of applying mechanical impact may be mixing by a mechanical milling method, as an example. Specifically, the method may be mixing using a ball mill apparatus. When the starting compounds are mixed with a ball mill apparatus, for example, the platform rotation speed and mixing time are not particularly restricted.

The starting compounds are not particularly restricted. For a fluoride ion conductor wherein A is K and x=0 in formula (1), i.e. containing no Sr, the starting compounds will be BaF₂, KF and LiF, for example. For a fluoride ion conductor wherein A is K and 0<x<0.4 in formula (1), i.e. containing Sr, the starting compounds will be BaF₂, SrF₂, KF and LiF, for example. When A is K is not satisfied, the corresponding alkali metal fluoride may be used. Such starting compounds may be prepared by common methods, or they may be commercial products.

### <<Negative Electrode Mixture>>

The negative electrode mixture of the disclosure comprises a fluoride ion conductor and a negative electrode active material, and optionally also a conductive aid and a binder. For the purpose of the disclosure, “negative electrode mixture” means a composition that can form a negative electrode active material layer, either alone or by further comprising other components.

### <Fluoride Ion Conductor>

The fluoride ion conductor will be understood by referring to the description herein regarding the fluoride ion conductor of the disclosure.

### <Negative Electrode Active Material>

The negative electrode active material is not particularly restricted, and examples include low-potential negative electrode active materials such as CeF₃ and LaF₃. Since the fluoride ion conductor of the disclosure has high reduction resistance, it can be used in combination with such types of negative electrode active materials.

### <Conductive Aid>

The conductive aid may be a carbon material, for example. Examples of carbon materials include carbon blacks such as acetylene black, Ketjen black, furnace black and thermal black, as well as graphene, fullerene and carbon nanotubes.

### <Binder>

Examples of binders include fluorine-based binders such as polyvinylidene fluoride (PVdF) and polytetrafluoroethylene (PTFE).

The method of preparing the negative electrode mixture is not particularly restricted, and it may be a method of mixing components that can form a negative electrode mixture, for example. The mixing method may be a mechanical milling method, as an example. Specifically, the method may be mixing using a ball mill apparatus. When the starting compounds are mixed with a ball mill apparatus, for example, the platform rotation speed and mixing time are not particularly restricted.

### <<Fluoride Ion Battery>>

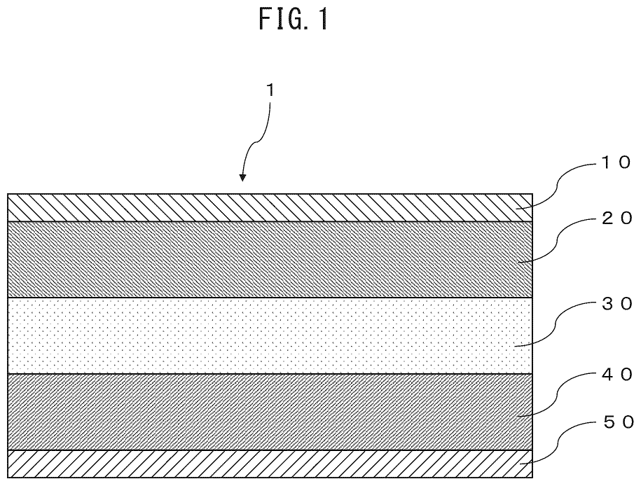

As illustrated in FIG. 1, the fluoride ion battery 1 of the disclosure has a negative electrode active material layer 20, the negative electrode active material layer comprising a negative electrode mixture of the disclosure. The fluoride ion battery 1 of the disclosure may have a negative electrode collector layer 10, a negative electrode active material layer 20 comprising a negative electrode mixture of the disclosure, an electrolyte layer 30, a positive electrode active material layer 40 and a positive electrode collector layer 50, in that order.

The fluoride ion battery of the disclosure may be a liquid battery comprising an electrolyte solution as the electrolyte layer, or it may be a solid-state battery having a solid electrolyte layer as the electrolyte layer. The term “solid-state battery” as used herein refers to a battery using at least a solid electrolyte as the electrolyte, and the solid-state battery may also employ a combination of a solid electrolyte and a liquid electrolyte as the electrolyte. Alternatively, the solid-state battery of the disclosure may be an all-solid-state battery, i.e. a battery employing only a solid electrolyte as the electrolyte.

The elements of the fluoride ion battery of the disclosure will now be described.

### <Negative Electrode Collector Layer>

Examples of materials for the negative electrode collector layer include stainless steel (SUS), copper, nickel, iron, titanium, platinum and carbon.

The form of the negative electrode collector layer may be a foil, mesh or porous form.

### <Negative Electrode Active Material Layer>

The negative electrode active material layer may comprise a negative electrode mixture of the disclosure. The negative electrode mixture of the disclosure will be understood by referring to the description herein regarding the negative electrode mixture of the disclosure.

The thickness of the negative electrode active material layer is not particularly restricted and may be appropriately set depending on the battery construction.

### <Electrolyte Layer>

When the fluoride ion battery of the disclosure is a liquid battery, the electrolyte layer may be composed of an electrolyte solution and optionally a separator, for example.

The electrolyte solution may comprise a fluoride salt and an organic solvent, for example.

The separator is not particularly restricted so long as it has a composition that can withstand the range of uses for a fluoride ion battery.

When the fluoride ion battery of the disclosure is a solid-state battery, the electrolyte layer may include a solid electrolyte layer, for example. The electrolyte layer in this case may optionally comprise a binder.

The solid electrolyte is not particularly restricted so long as it is a material that can be used in a fluoride ion battery. For example, the solid electrolyte may be the same as the fluoride ion conductor of the disclosure in the negative electrode active material layer.

The binder will be understood by referring to the description herein regarding the negative electrode mixture of the disclosure.

### <Positive Electrode Active Material Layer>

The positive electrode active material layer of the disclosure is a layer comprising at least a positive electrode active material. The positive electrode active material layer may also optionally comprise a solid electrolyte, a conductive aid and a binder.

The positive electrode active material will usually be an active material that is defluorinated during discharge. Examples of positive electrode active materials include simple metals, alloys and metal oxides, as well as their fluorides. Examples of metal elements to be included in the positive electrode active material include Cu, Ag, Ni, Co, Pb, Mn, Au, Pt, Rh, V, Os, Ru, Fe, Cr, Bi, Nb, Sb, Ti, Sn and Zn.

The solid electrolyte used may be one commonly used as a solid electrolyte for fluoride ion batteries.

The conductive aid and binder will be understood by referring to the description herein regarding the negative electrode mixture of the disclosure.

The thickness of the positive electrode active material layer is not particularly restricted and may be appropriately set depending on the battery construction.

### <Positive Electrode Collector Layer>

Examples of materials for the positive electrode collector layer include lead, stainless steel (SUS), aluminum, nickel, iron, titanium, platinum and carbon.

The form of the positive electrode collector may be a foil, mesh or porous form.

### EXAMPLES

### Example 1

### Synthesis of Fluoride Ion Conductor

Barium fluoride (BaF₂) (Aldrich), potassium fluoride (KF) (Aldrich) and lithium fluoride (LiF) (Aldrich) were weighed out to a composition of Ba_{0.95}K_{0.05}LiF_{2.95}. The starting compounds were mixed with a planetary ball mill at 600 rpm for 12 hours to synthesize a fluoride ion conductor for Example 1.

### <Evaluation>

### (X-Ray Diffraction Measurement)

The fluoride ion conductor of Example 1 was measured by X-ray diffraction (XRD) using a Smartlab CuKal line source (product of Rigaku Corp.) in an argon atmosphere, under conditions with a measuring range of 10-60°, a scan speed of 1.5°/min and a measuring interval of 0.01°.

### (Evaluation of Ion Conductivity)

The fluoride ion conductor of Example 1 was molded by uniaxial pressing at 340 MPa and evaluated for ion conductivity using the formed green compact. Specifically, gold dust was press molded above and below the green compact to bond gold electrodes, and the alternating current impedance was measured for evaluation at an applied voltage 100 mV in a range of 7 MHz to 0.5 Hz. The measurement was conducted under an argon stream in a range of 25° C. to 400° C.

### (Evaluation of Potential Window)

The fluoride ion conductor of Example 1 and acetylene black (AB) (Denka Co., Ltd.) were weighed out to a mass ratio of 90:10. They were then mixed with a ball mill under conditions of 100 rpm, 3 hours. An electrode mixture was thus obtained.

The electrolyte used was the fluoride ion conductor of Example 1.

Lead fluoride (PbF₂) (Aldrich) and AB (Denka Co., Ltd.) were weighed out to a mass ratio of 95:5. They were then mixed with a ball mill under conditions of 600 rpm, 3 hours. A counter electrode composite material was thus obtained.

An evaluation cell was fabricated by laminating a platinum (Pt) foil, the layered electrode mixture (electrode mixture layer), the layered electrolyte (electrolyte layer), the layered counter electrode composite material (counter electrode composite material layer) a lead (Pb) foil and an aluminum (Al) foil in that order, and powder-compacting the stack.

The fabricated evaluation cell was subjected to a charge-discharge test under conditions with −50 μAcm⁻², 150° C., and an ending potential of −2.7 V.

### (Battery Evaluation)

The fluoride ion conductor of Example 1, cerium fluoride (CeF₃) (Mitsuwa Chemicals Co., Ltd.) or lanthanum fluoride (LaF₃) (Aldrich), and AB (Denka Co., Ltd.) were weighed out in a mass ratio of 30:60:10. They were then mixed with a ball mill under conditions of 100 rpm, 3 hours. A negative electrode mixture was thus obtained.

The electrolyte used was the fluoride ion conductor of Example 1.

PbF₂ (Aldrich) and AB (Denka Co., Ltd.) were weighed out to a mass ratio of 95:5. They were then mixed with a ball mill under conditions of 600 rpm, 3 hours. A counter electrode composite material was thus obtained.

An evaluation cell was fabricated by laminating a Pt foil, the layered negative electrode mixture (negative electrode mixture layer), the layered electrolyte (electrolyte layer), the layered counter electrode composite material (counter electrode composite material layer), a Pb foil and an Al foil in that order, and powder-compacting the stack.

The fabricated evaluation cell was subjected to a charge-discharge test under conditions with ±50 μAcm-2, 150° C., and an ending potential of 0 to −2.7 V.

### Examples 2 to 17, Comparative Examples 1 to 6, and Reference Example

Fluoride ion conductors for Examples 2 to 17, Comparative Examples 1 to 6 and the Reference Example were synthesized in the same manner as Example 1 except for changing the composition as shown in Table 1, and were evaluated. For Examples 10 to 17 and Comparative Examples 4 to 6, strontium fluoride (SrF₂) (Alfa Aesar Co.) was used instead of the starting compound used in Example 1. For Comparative Example 1, BaF₂ and LiF were used as starting compounds. For Comparative Examples 2 and 3, BaF₂, SrF₂ and LiF were used as starting compounds. For the Reference Example, SrF₂ and LiF were used as starting compounds.

Table 1 shows the compositions of the fluoride ion conductors of each of the Examples, as well as their phase states, ion conductivities, activation energies and reduction capacities.

The evaluation results for each of the Examples are as follows;

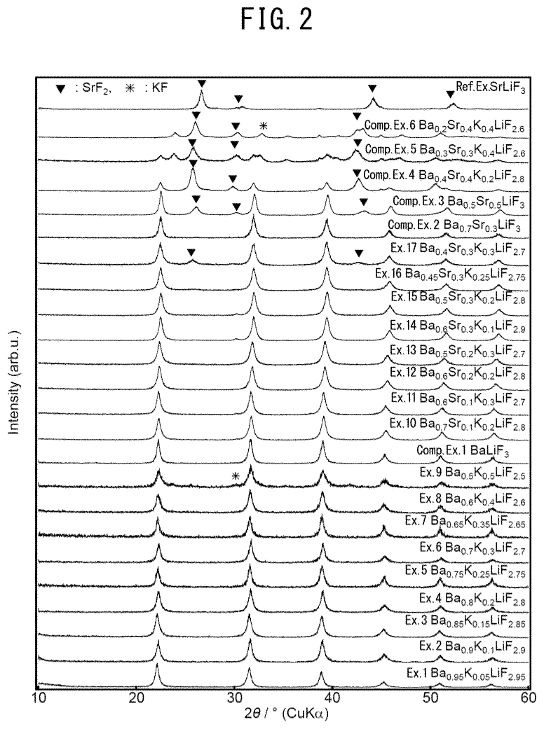

FIG. 2: XRD patterns for the fluoride ion conductors of Examples 1 to 17, Comparative Examples 1 to 6 and the Reference Example.

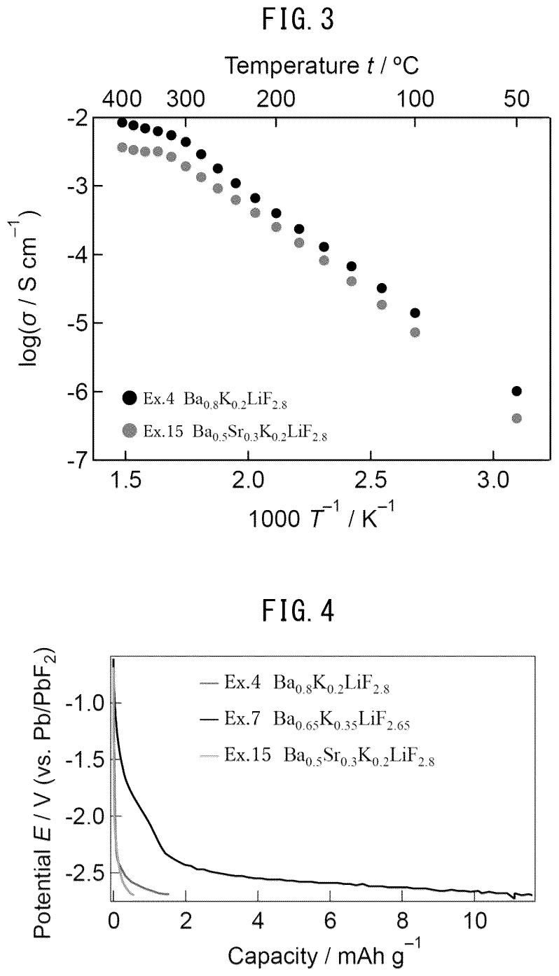

FIG. 3: Relationship between temperature and ion conductivity for the fluoride ion conductors of Examples 4 and 15.

FIG. 4: Charging curves for batteries comprising the fluoride ion conductors of Examples 4, 7 and 15, in an electrode mixture.

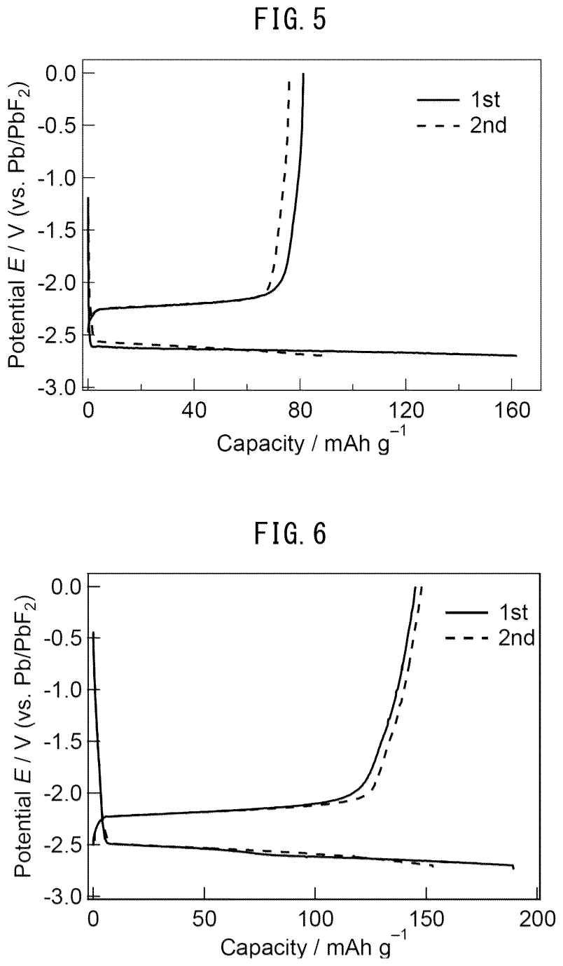

FIG. 5: Charge-discharge curves for a fluoride ion battery comprising LaF₃ as the negative electrode active material, and the fluoride ion conductor of Example 15, in a negative electrode mixture.

FIG. 6: Charge-discharge curves for a fluoride ion battery comprising CeF₃ as the negative electrode active material, and the fluoride ion conductor of Example 15, in a negative electrode mixture.

The activation energy was determined from the slope in the graph shown as an example in FIG. 3. The activation energy represents the temperature dependence of ion conductivity, with a larger activation energy corresponding to greater temperature dependence.

TABLE 1

| | | | Ionic | | |
|---|---|---|---|---|---|
| | | | conductivity | Activation | Reduction |
| | | | (25° C.) | energy | capacity |
| | Composition | Phase | [S/cm] | [kJ/mol] | [mAh/g] |
| Example 1 | Ba_{0.95}K_{0.05}LiF_{2.95} | Perovskite | 8.3E−09 | 59.2 | N.D. |
| Example 2 | Ba_{0.9}K_{0.1}LiF_{2.9} | Perovskite | 2.0E−07 | 49.5 | N.D. |
| Example 3 | Ba_{0.85}K_{0.15}LiF_{2.85} | Perovskite | 5.9E−08 | 55.3 | N.D. |
| Example 4 | Ba_{0.8}K_{0.2}LiF_{2.8} | Perovskite | 2.1E−07 | 53.9 | 1.51 |
| Example 5 | Ba_{0.75}K_{0.25}LiF_{2.75} | Perovskite | 3.3E−07 | 54.3 | N.D. |
| Example 6 | Ba_{0.7}K_{0.3}LiF_{2.7} | Perovskite | 2.9E−07 | 57 | N.D. |
| Example 7 | Ba_{0.65}K_{0.35}LiF_{2.65} | Perovskite | 2.8E−07 | 58.8 | 12.23 |
| Example 8 | Ba_{0.6}K_{0.4}LiF_{2.6} | Perovskite | 1.4E−07 | 60.4 | N.D. |
| Example 9 | Ba_{0.5}K_{0.5}LiF_{2.5} | Perovskite, KF | 2.7E−08 | 61.9 | N.D. |
| Comp. Example 1 | BaLiF₃ | Perovskite | 1.1E−11 | 68.4 | N.D. |
| Example 10 | Ba_{0.7}Sr_{0.1}K_{0.2}LiF_{2.8} | Perovskite | 9.5E−08 | 58.7 | 2.52 |
| Example 11 | Ba_{0.6}Sr_{0.2}K_{0.3}LiF_{2.7} | Perovskite | 1.3E−07 | 60.7 | 8.81 |
| Example 12 | Ba_{0.6}Sr_{0.2}K_{0.2}LiF_{2.8} | Perovskite | 8.5E−08 | 57.8 | 0.86 |
| Example 13 | Ba_{0.5}Sr_{0.2}K_{0.3}LiF_{2.7} | Perovskite | 4.0E−08 | 59.9 | 1.88 |
| Example 14 | Ba_{0.6}Sr_{0.3}K_{0.1}LiF_{2.9} | Perovskite | 6.9E−08 | 52.2 | 0.43 |
| Example 15 | Ba_{0.5}Sr_{0.3}K_{0.2}LiF_{2.8} | Perovskite | 9.3E−08 | 55.9 | 0.56 |
| Example 16 | Ba_{0.45}Sr_{0.3}K_{0.25}LiF_{2.75} | Perovskite | 6.8E−08 | 62.6 | 3.13 |
| Example 17 | Ba_{0.4}Sr_{0.3}K_{0.3}LiF_{2.7} | Perovskite, SrF₂ | 2.1E−08 | 62.3 | N.D. |
| Comp. Example 2 | Ba_{0.7}Sr_{0.3}LiF₃ | Perovskite | 8.9E−11 | 62.6 | N.D. |
| Comp. Example 3 | Ba_{0.5}Sr_{0.5}LiF₃ | Perovskite, SrF₂ | N.D. | N.D. | N.D. |
| Comp. Example 4 | Ba_{0.4}Sr_{0.4}K_{0.2}LiF_{2.8} | Perovskite, SrF₂ | N.D. | N.D. | N.D. |
| Comp. Example 5 | Ba_{0.3}Sr_{0.3}K_{0.4}LiF_{2.6} | Perovskite, SrF₂ | N.D. | N.D. | N.D. |
| Comp. Example 6 | Ba_{0.2}Sr_{0.4}K_{0.4}LiF_{2.6} | Perovskite, SrF₂ | 4.0E−11 | 74.6 | N.D. |
| Reference Example | SrLiF₃ | Perovskite, SrF₂ | N.D. | N.D. | N.D. |

* “N.D.” means “No Data”

As seen in Table 1, the batteries of the Examples which had fluoride ion conductors of the disclosure had higher ion conductivities than the batteries of the Comparative Examples.

With the fluoride ion conductors of Comparative Example 6 which had low ion conductivity despite a compositional formula of Ba_{1-x-y}SrₓA_{y}LiF_{3-y}, and of Comparative Examples 4 and 5 which had low estimated ion conductivities, the proportion of SrF₂ impurity which did not contribute to ion conduction was high, as shown in FIG. 2, suggesting that the ion conductivity was therefore low, or estimated to be low.

As shown in FIG. 2, the fluoride ion conductors of the Examples exhibited XRD peaks with 100, 110, 111, 200 and 210 reflection of the perovskite structure near 22°, 32°, 39°, 45° and 51°.

As shown in FIG. 3 and Table 1, based on comparison between the fluoride ion conductor of Example 4 and the fluoride ion conductor of Example 15, the fluoride ion conductor of Example 4 had higher ion conductivity.

As shown in FIG. 4 and Table 1, with the fluoride ion conductors of Examples 4 and 15, the potential window for reduction was wider and the reduction capacity was smaller, i.e. the reduction resistance was more satisfactory, compared to the fluoride ion conductor of Example 7. This is likely because with the batteries of Examples 4 and 15, the parameters indicating the compositional ratio in formula (1) were within effective ranges for exhibiting satisfactory reduction resistance.

As shown in FIGS. 5 and 6, with the fluoride ion batteries having LaF₃ or CeF₃ as negative electrode active materials in the negative electrode mixture, and the fluoride ion conductor of Example 15, no short circuiting occurred due to decomposition of the fluoride ion conductor, and reversible charge-discharge reaction was confirmed.

### Examples 18 to 28 and Comparative Example 7

Fluoride ion conductors for Examples 18 to 28 and Comparative Example 7 were synthesized in the same manner as Example 1 except for changing the composition as shown in Table 2, and were evaluated.

Table 2 shows the compositions of the fluoride ion conductors of each of the Examples, as well as their phase states, ion conductivities, activation energies and reduction capacities.

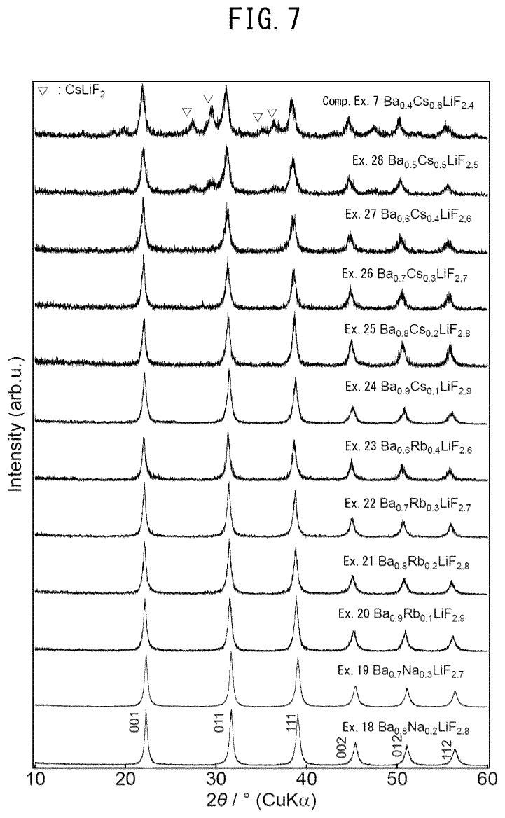

FIG. 7 shows the XRD patterns for each of the fluoride ion conductors.

TABLE 2

| | | | Ionic | | |
|---|---|---|---|---|---|
| | | | conductivity | Activation | Reduction |
| | | | (25° C.) | energy | capacity |
| | Composition | Phase | [S/cm] | [kJ/mol] | [mAh/g] |
| Example 18 | Ba_{0.8}Na_{0.2}LiF_{2.8} | Perovskite | 5.0E−09 | 64.3 | N.D. |
| Example 19 | Ba_{0.7}Na_{0.3}LiF_{2.7} | Perovskite | 4.8E−09 | 65.3 | N.D. |
| Example 20 | Ba_{0.9}Rb_{0.1}LiF_{2.9} | Perovskite | 3.2E−07 | 48.7 | N.D. |
| Example 21 | Ba_{0.8}Rb_{0.2}LiF_{2.8} | Perovskite | 1.8E−07 | 54.8 | N.D. |
| Example 22 | Ba_{0.7}Rb_{0.3}LiF_{2.7} | Perovskite | 3.3E−07 | 51.9 | N.D. |
| Example 23 | Ba_{0.6}Rb_{0.4}LiF_{2.6} | Perovskite | 2.5E−07 | 52.6 | N.D. |
| Example 24 | Ba_{0.9}Cs_{0.1}LiF_{2.9} | Perovskite | 2.8E−08 | 55.6 | N.D. |
| Example 25 | Ba_{0.8}Cs_{0.2}LiF_{2.8} | Perovskite | 4.3E−08 | 58.2 | N.D. |
| Example 26 | Ba_{0.7}Cs_{0.3}LiF_{2.7} | Perovskite | 2.6E−08 | 61.5 | N.D. |
| Example 27 | Ba_{0.6}Cs_{0.4}LiF_{2.6} | Perovskite | 1.4E−08 | 62.2 | N.D. |
| Example 28 | Ba_{0.5}Cs_{0.5}LiF_{2.5} | Perovskite, CsLiF₂ | N.D. | N.D. | N.D. |
| Comp. Example 7 | Ba_{0.4}Cs_{0.6}LiF_{2.4} | Perovskite, CsLiF₂ | N.D. | N.D. | N.D. |
| Comp. Example 1 | BaLiF₃ | Perovskite | 1.1E−11 | 68.4 | N.D. |

* “N.D.” means “No Data”

As seen in Table 2, with the fluoride ion conductors of Examples 18 to 27 which had Na, Rb or Cs instead of K as the alkali metal element A, the ion conductivities were higher than the fluoride ion conductor of Comparative Example 1.

With the fluoride ion conductor of Example 28, the ion conductivity is expected to be even lower than the fluoride ion conductors of Examples 24 to 27, due to the presence of CsLiF₂ as an impurity which does not contribute to ion conduction. However, judging from the relationship between Examples 8 and 9 which had similar compositional ratios for Ba and A as Examples 27 and 28, the fluoride ion conductor of Example 28 was expected to have even higher ion conductivity than the fluoride ion conductor of Comparative Example 1.

In contrast, the fluoride ion conductor of Comparative Example 7 which had a high ratio of CsLiF₂ as an impurity that does not contribute to ion conduction, as shown in FIG. 7, was expected to have similar low ion conductivity as Comparative Example 1.

As shown in FIG. 7, the fluoride ion conductors of the Examples exhibited XRD peaks with 100, 110, 111, 200 and 210 reflection of the perovskite structure near 22°, 32°, 39°, 45° and 51°.

### REFERENCE SIGNS LIST

1 Fluoride ion battery
10 Negative electrode collector layer
20 Negative electrode active material layer
30 Electrolyte layer
40 Positive electrode active material layer
50 Positive electrode collector layer

1. A fluoride ion conductor having a perovskite structure, and represented by the following formula (1): 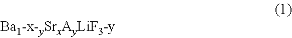
wherein;
A is an alkali metal element selected from among Na, K, Rb and Cs,
$$0.3 < 1 - x - y < 1. , 0 \leq x < 0.4 , and \\ 0 < y < 0.6 .$$

2. The fluoride ion conductor according to claim 1, wherein
(i) in formula (1):
$$x = 0 , and \\ 0 < y \leq 0.3 ,$$
or
(ii) in formula (1):
$$0.4 < 1 - x - y < 1. , 0 < x < 0.4 , 0 < y < 0.4 , and \\ 2 y - x \leq 0.4 .$$

3. The fluoride ion conductor according to claim 1, wherein in formula (1), A is K.

4. A negative electrode mixture comprising a fluoride ion conductor according to claim 1.

5. A fluoride ion battery,
having a negative electrode active material layer,
wherein the negative electrode active material layer comprises a negative electrode mixture according to claim 4.
